(19) United States
(12) Patent Application Publication
(10) Pub. No.: US 2025/0038607 A1
(43) Pub. Date: Jan. 30, 2025

(54) BRUSHLESS MOTOR FOR A POWER TOOL

(71) Applicant: MILWAUKEE ELECTRIC TOOL CORPORATION, Brookfield, WI (US)

(72) Inventors: Linnea Emerson, Lisbon, WI (US); Jeffrey C. Hessenberger, Neosho, WI (US)

(21) Appl. No.: 18/716,354

(22) PCT Filed: Dec. 14, 2022
(86) PCT No.: PCT/US22/81553

§ 371 Date: Jun. 4, 2024

Related U.S. Application Data
(60) Provisional application No. 63/290,887, filed on Dec. 17, 2021.

(51) Int. Cl. H02K 3/52; H02K 7/14; H02K 15/00

(52) U.S. Cl. CPC H02K 3/521; H02K 7/145; H02K 15/0062; H02K 15/0068

(57) ABSTRACT

Power tools described herein may include a housing, a motor, and a plurality of terminals. A slot may be formed between at least two terminal posts protruding from a surface of each terminal. A motor wire may be configured to be secured to its respective terminal within the slot by pressing a tip of a first electrode into contact with an outer portion of at least one terminal post of the at least two terminal posts, and performing a securing process (e.g., welding, fusing, etc.) by controlling current to pass through the first electrode to a second electrode that is also in contact with the respective terminal. The tip of the first electrode may be configured to prevent the at least one terminal post from moving outwardly away from a center of the respective terminal during the performance of the securing process.

### RELATED APPLICATIONS

This application claims priority to U.S. Provisional Patent Application No. 63/290,887, filed Dec. 17, 2021, the entire content of which is hereby incorporated by reference.

### FIELD

The present disclosure relates to a brushless motor for a power tool.

### BACKGROUND

Power tools generally include a motor connected to a power source to power the tool. One such motor is a brushed direct current (“DC”) motor. In brushed DC motors, motor brushes make and break electrical connection to the motor due to rotation of the rotor. Conventionally, brushed DC motors were used in power tools for their relative ease of manufacture and low cost.

### SUMMARY

Brushed DC motors have several drawbacks when used in power tools. One drawback of brushed DC motors is that the brushes eventually wear out, reducing the longevity of the power tool. Further, because the brushes are making and breaking electrical connection, there may be sparks and electrical noise within the power tool. A brushless DC motor is another type of motor used in power tools. A brushless DC motor uses electronically controlled switches to selectively apply power to coils of a motor to drive a rotor, rather than brushes.

Embodiments of the disclosure include a power tool that may include a housing, and a brushless direct current (DC) motor located within the housing and having a rotor and a stator. The rotor may be coupled to a motor shaft arranged to produce an output outside of the housing. The power tool may further include a plurality of terminals mounted on an outer circumference of the stator. Each terminal of the plurality of terminals may include at least two terminal posts protruding from a surface of the terminal away from a motor axis about which the rotor is configured to rotate. A slot may be formed between the at least two terminal posts. The slot may be configured to receive a motor wire. The motor wire received in each slot of each terminal is configured to be secured to its respective terminal. To secure the motor wire to its respective terminal a tip of a first electrode is pressed into contact with an outer portion of at least one terminal post of the at least two terminal posts, and a current is controlled to pass through the first electrode to a second electrode that is also in contact with the respective terminal. The current generates heat to conjoin the respective motor wire and the respective terminal. The tip of the first electrode is configured to prevent the at least one terminal post from moving outwardly away from a center of the respective terminal when being secured.

In some aspects, to press the tip of the first electrode into contact with the outer portion of the at least one terminal post, the tip of the first electrode is pressed into contact with respective outer portions of two terminal posts of the at least two terminal posts.

In some aspects, the tip of the first electrode includes a U-shaped shank configured to contact the outer portion of each of two outer terminal posts of the at least two terminal posts.

In some aspects, the U-shaped shank is one of cylindrically shaped and rectangularly shaped.

In some aspects, to secure the motor wire to its respective terminal, a tip of the second electrode is pressed into contact with an outer portion of a second terminal post of the at least two terminal posts. The second terminal post is located on a laterally opposite side of the surface of the respective terminal as the at least one terminal post. The tip of the second electrode is configured to prevent the second terminal post from moving outwardly away from the center of the respective terminal when being secured.

In some aspects, the tip of the first electrode includes a V-shaped cutout configured to

contact an outer edge of the at least one terminal post. The tip of the second electrode includes the V-shaped cutout configured to contact an outer edge of the second terminal post.

In some aspects, the first electrode includes a positive electrode and the second electrode includes a negative electrode.

In some aspects, the motor wire is one of welded, fused, or a combination of being welded and fused to its respective terminal.

Embodiments of the disclosure also include a method of assembling a motor. The method may include for each respective terminal of a plurality of terminals, inserting a portion of a motor wire into a slot on the respective terminal. The slot may be formed by at least two terminal posts protruding from a surface of the respective terminal. The method may further include, for each respective terminal of the plurality of terminals, pressing a tip of a first electrode into contact with an outer portion of at least one terminal post of the at least two terminal posts, and performing a securing process by controlling current to pass through the first electrode to a second electrode that is also in contact with the respective terminal. The current may generate heat to conjoin the wire and the terminal. The tip of the first electrode may be configured to prevent the at least one terminal post from moving outwardly away from a center of the terminal during the performance of the securing process. The method may further include mounting the plurality of terminals on an outer circumference of the motor adjacent to each other and in an orientation such that the at least two terminal posts protrude away from a motor axis about which a rotor of the motor is configured to rotate. The method may further include installing the motor in a housing of a power tool.

In some aspects, the method further includes pressing the tip of the first electrode into contact with the outer portion of the at least one terminal post includes pressing the tip of the first electrode into contact with respective outer portions of two terminal posts of the at least two terminal posts.

In some aspects, the tip of the first electrode includes a U-shaped shank configured to contact the outer portion of each of two outer terminal posts of the at least two terminal posts.

In some aspects, the U-shaped shank is one of cylindrically shaped and rectangularly shaped.

In some aspects, the method further includes pressing a tip of the second electrode into contact with an outer portion of a second terminal post of the at least two terminal posts. The second terminal post is located on a laterally opposite side of the surface of the terminal as the at least one terminal post. The tip of the second electrode is configured to prevent the second terminal post from moving outwardly away from the center of the terminal during the securing process.

In some aspects, the tip of the first electrode includes a V-shaped cutout configured to contact an outer edge of the at least one terminal post. The tip of the second electrode includes the V-shaped cutout configured to contact an outer edge of the second terminal post.

In some aspects, the first electrode includes a positive electrode and the second electrode includes a negative electrode.

In some aspects, performing the securing process includes welding, fusing, or a combination of welding and fusing.

Embodiments of the disclosure also include a method of securing a wire to a terminal. The method may include inserting a portion of the wire into a slot on the terminal. The slot may be formed by at least two terminal posts protruding from a surface of the terminal. The method may further include pressing a tip of a first electrode into contact with an outer portion of at least one terminal post of the at least two terminal posts. The method may further include performing a securing process by controlling current to pass through the first electrode to a second electrode that is also in contact with the terminal. The current may generate heat to conjoin the wire and the terminal. The tip of the first electrode may be configured to prevent the at least one terminal post from moving outwardly away from a center of the terminal during the performance of the securing process.

In some aspects, the tip of the first electrode includes a U-shaped shank configured to contact the outer portion of each of two outer terminal posts of the at least two terminal posts.

In some aspects, the method further includes pressing a tip of the second electrode into contact with an outer portion of a second terminal post of the at least two terminal posts. The second terminal post is located on a laterally opposite side of the surface of the terminal as the at least one terminal post. The tip of the second electrode is configured to prevent the second terminal post from moving outwardly away from the center of the terminal during the securing process.

In some aspects, the tip of the first electrode includes a V-shaped cutout configured to contact an outer edge of the at least one terminal post. The tip of the second electrode includes the V-shaped cutout configured to contact an outer edge of the second terminal post.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a power tool incorporating a brushless DC motor.

FIG. 2 illustrates a block diagram of a brushless power tool, such as illustrated in FIG. 1.

FIGS. 3A and 3B illustrate a motor stator according to embodiments described herein.

FIGS. 4A, 4B, and 4C illustrate a motor terminal, according to embodiments described herein.

FIG. 5 illustrates electrodes of a machine that are being used to secure motors wires to the motor terminal of FIGS. 4A, 4B, and 4C, according to some embodiments described herein.

FIGS. 6A and 6B illustrate a fusing tip for one or both of the electrodes shown in FIG. 5 to secure the motors wires to the motor terminal of FIGS. 4A, 4B, and 4C, according to embodiments described herein.

FIGS. 7A and 7B illustrate the fusing tip of FIGS. 6A and 6B contacting the motor terminal of FIGS. 4A, 4B, and 4C, according to embodiments described herein.

FIGS. 8A and 8B illustrate another fusing tip for one or both of the electrodes shown in FIG. 5 to secure the motors wires to the motor terminal of FIGS. 4A, 4B, and 4C, according to embodiments described herein.

FIGS. 9A and 9B illustrate the fusing tips of FIGS. 8A and 8B contacting the motor terminal of FIGS. 4A, 4B, and 4C, according to embodiments described herein.

### DETAILED DESCRIPTION

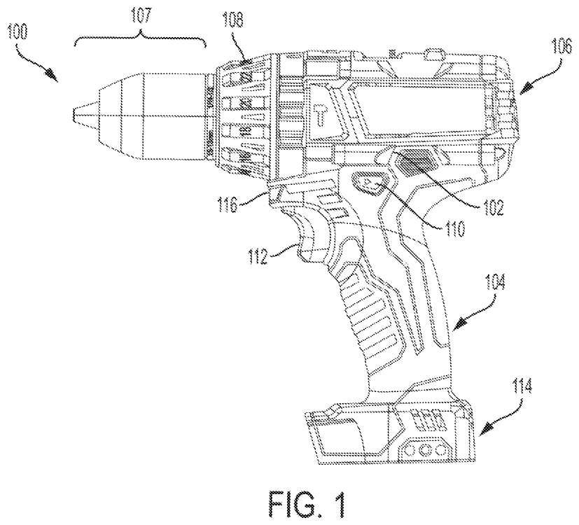

FIG. 1 illustrates a power tool 100 incorporating a brushless direct current (DC) motor. In a brushless motor power tool, such as power tool 100, switching elements are selectively enabled and disabled by control signals from a controller to selectively apply power from a power source (e.g., battery pack) to drive a brushless motor. The power tool 100 is illustrated as a brushless hammer drill having a housing 102 with a handle portion 104 and motor housing portion 106. The power tool 100 further includes an output unit 107, torque setting dial 108, forward/reverse selector 110, trigger 112, battery pack interface 114, and light 116. Although FIG. 1 illustrates a hammer drill, in some embodiments, the motors described herein are incorporated into other types of power tools including drills/drivers, impact drivers, impact wrenches, circular saws, reciprocating saws, string trimmers, leaf blowers, vacuums, and the like.

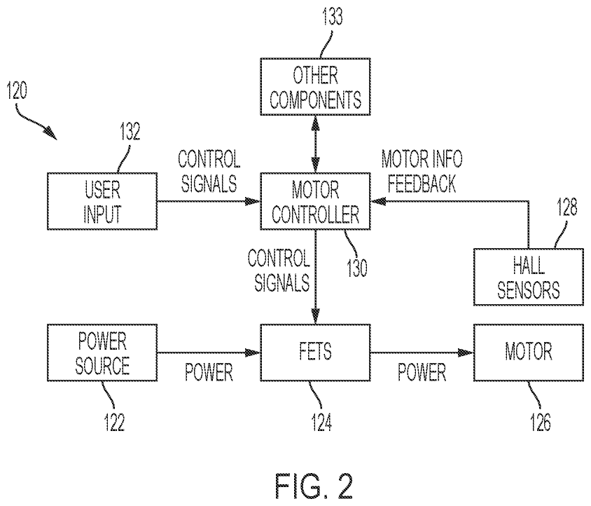

FIG. 2 illustrates a simplified block diagram 120 of the brushless power tool 100, which includes a power source 122, Field Effect Transistors (FETs) 124, a motor 126, Hall effect sensors 128, a motor controller 130, user input 132, and other components 133 (battery pack fuel gauge, work lights (LEDs), current/voltage sensors, etc.). The power source 122 provides DC power to the various components of the power tool 100 and may be a power tool battery pack that is rechargeable and uses, for instance, lithium ion cell technology. In some instances, the power source 122 may receive AC power (e.g., 120V/60 Hz) from a tool plug that is coupled to a standard wall outlet, and then filter, condition, and rectify the received power to output DC power. Each Hall effect sensor 128 outputs motor feedback information, such as an indication (e.g., a pulse) when a magnet of the rotor rotates across the face of that Hall sensor. Based on the motor feedback information from the Hall sensors 128, the motor controller 130 can determine the position, velocity, and acceleration of the rotor. The motor controller 130 also receives user controls from user input 132, such as by depressing the trigger 112 or shifting the forward/reverse selector 110. In response to the motor feedback information and user controls, the motor controller 130 transmits control signals to control the FETs 124 to drive the motor 126. By selectively enabling and disabling the FETs 124, power from the power source 122 is selectively applied to stator coils of the motor 126 to cause rotation of a rotor. Although not shown, the motor controller 130 and other components of the power tool 100 are electrically coupled to the power source 122 such that the power source 122 provides power thereto.

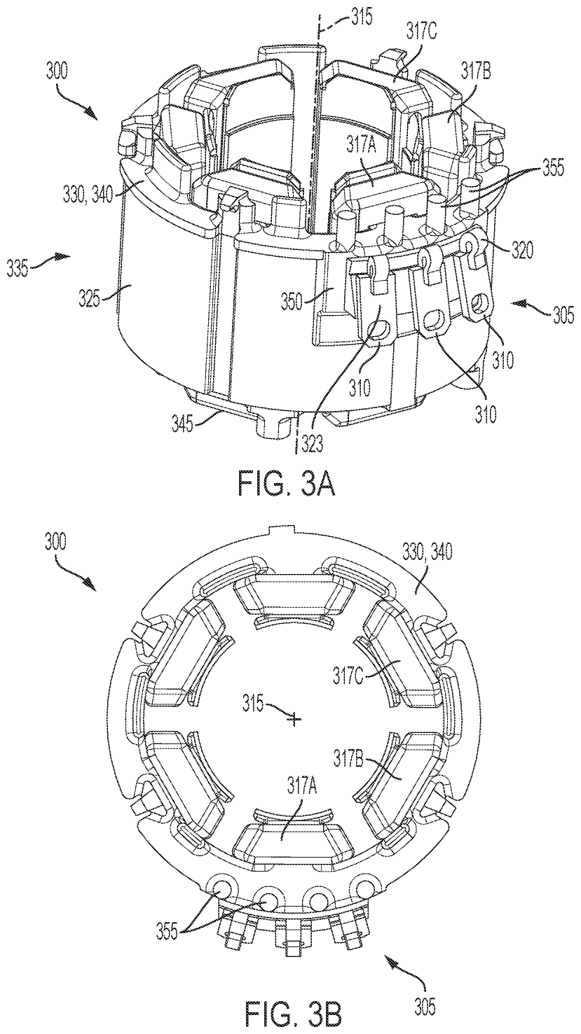

Various embodiments of the motor 126 are illustrated and described with respect to FIGS. 3A-3B. Any terminal design can be used with any motor or stator disclosed herein. For example, terminals disclosed as being located on a single terminal mount may alternatively be individually located around the outer circumference of the stator (e.g., spaced approximately 120° apart), and terminals disclosed as being located around the outer circumference of the stator (e.g., spaced approximately 120° apart) may be alternatively located on a single terminal mount.

FIGS. 3A-3B illustrate a motor 300 that includes a terminal assembly 305 with a plurality of terminals 310. The terminals may be mounted on a terminal mount that may be made of resin, rubber, or another non-conductive material. In some embodiments, stator coils (i.e., stator windings, wire leads, stator winding leads) 317A-C are soldered, resistance welded, or fused to the one end of the terminals 310. For example, an end of a stator coil 317 is soldered, resistance welded, or fused to a compressed tang loop 320 on a first end of a terminal 310. In some embodiments, a wire connecting the terminal 310 to the power source 122 via the FETs 124 is soldered or otherwise connected to a second end of the terminal 310 that is opposite to the first end of the terminal 310 where the tang loop 320 is located.

The stator coils 317 are energized to produce a magnetic field. The stator coils 317 are electrically connected to corresponding phase wires via the terminals 310. In other words, the phase wires are electrically connected to the stator coils 317. The stator coils 317 are selectively energized by the power source 122 via the FETs 124, for example. In the illustrated embodiment, the stator coils 317 include three phases. The three phases of the stator coils 317 can be connected to each other in a delta, wye, or any other suitable configuration.

As shown in FIGS. 3A-3B, in some embodiments, the motor 300 includes a lamination stack 325, a stator molding 330 that is molded or holds to the lamination stack 325 to form a molded stator body 335 (FIG. 3A). The stator molding 330 of the molded stator body 335 includes a first axial end portion 340, a second axial end portion 345, and an extending portion 350 extending axially along an outer circumferential/peripheral surface of the lamination stack 325. The extending portion 350 is curved along the outer circumferential surface of the lamination stack 325. In the illustrated embodiment, the extending portion 350 extends from the first axial end portion 340 at least partially between the first axial end portion 340 and the second axial end portion 345. The stator molding 330 includes posts 355 formed extending away from the first axial end portion 340. The posts 355 are wire routing features that aid in the process of winding the stator coils 317 onto the molded stator body 335.

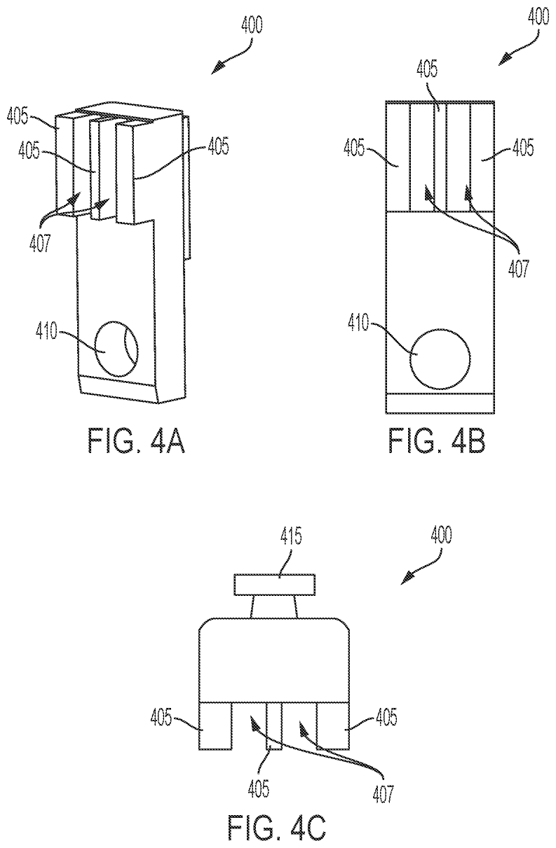

FIGS. 4A, 4B, and 4C illustrate a terminal 400 that can be attached to the motor 300 (e.g., in place of the terminals 310 shown in FIGS. 3A-3B). The terminal 400 includes a plurality of terminal posts 405 arranged parallel to one another at a first end of the terminal 400. Slots 407 may be located in between the terminal posts 405 and configured to receive wires such as motor windings. Wires (e.g., multiples passes of a motor winding) may be pressed into the slots 407 and then secured to the terminal 400 using, for example, a securing method including soldering, welding, and/or fusing. In some instances, the securing method may be executed by a securing a machine (e.g., a soldering gun, a welding machine/tool, a fusing machine/tool, etc.). The terminal 400 also includes a terminal aperture 410 at a second end of the terminal 400. In some embodiments, the terminals posts 405 are configured to connect to a positive power line for the motor 300, and the terminal aperture 410 is configured to connect to a negative power line for the motor 300. In other embodiments, the terminals posts 405 are configured to connect to the negative power line for the motor 300, and the terminal aperture 410 is configured to connect to the positive power line for the motor 300. The terminal 400 also includes a terminal mounting post 415 for securing the terminal 400 to the motor 300. For example, a non-conductive mount may be included on the extending portion 350. The non-conductive mount may include a plurality of grooves such that each groove is configured to receive a terminal mounting post 415 of a respective terminal 400.

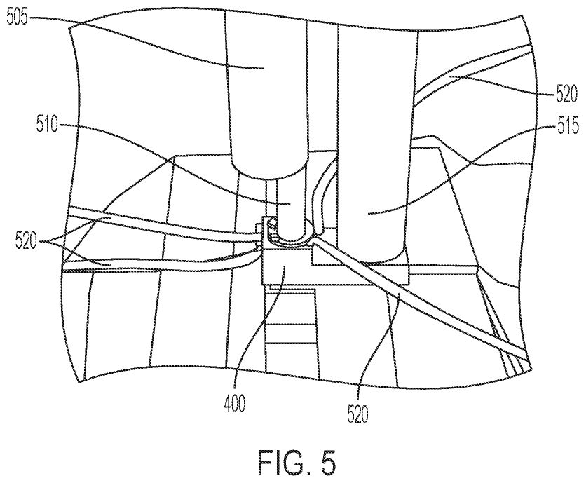

As indicated above, a securing method such as welding (e.g., fusion welding) may be used to secure motor wires 520 in the slots 407 of each terminal 400 (see FIG. 5). For example, fusion welding may involve a positive electrode 505 and a negative electrode 515 (see FIG. 5) through which a current is applied to the terminal 400 and the motor wires 520 until the motor wires become hot enough to melt and conjoin with the terminal 400. In some instances, an intermediate filler metal may be used during the welding process to join the terminal 400 and the motors wires 520 to create an electrical and a physical connection therebetween.

An electrode fusing tip 510 (i.e., an end of the electrode that contacts the terminal 400 and/or the motor wires 520) of one of the electrodes 505, 515 used for welding (e.g., the positive electrode 505) are often substantially flat. For example, FIG. 5 illustrates an electrode 505 with a cylindrical tip 510 that is substantially flat. Additionally, pressure by one or both of the fusing tips 510 of the electrodes 505, 515 is often applied to the terminal 400 during the welding process. Accordingly, during the welding process, portions of a terminal 400 may often become deformed. For example, one or both of the outer terminal posts 405 may be pushed outwardly away from the center terminal post 405. Such deformation is not desirable, especially when the terminals 400 are located in close proximity next to each other (as is the case in many power tools where space is limited and compact design is desired) as shown in FIGS. 3A-3B that show terminals 310. For example, outwardly deformed outer terminal posts 405 may increase a chance of short circuit between adjacent terminals 400, 310. Thus, there is a technological problem with the welding process for terminals of a motor.

This disclosure addresses this technological problem by providing one or more electrode fusing tips and/or securing methods that provide mechanical stability to the outer terminal posts 405 during a securing process (e.g., welding) that secures motor wires 520 to a terminal 400.

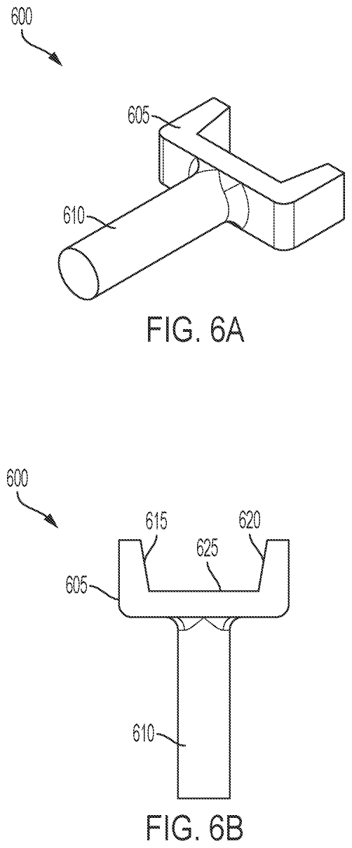

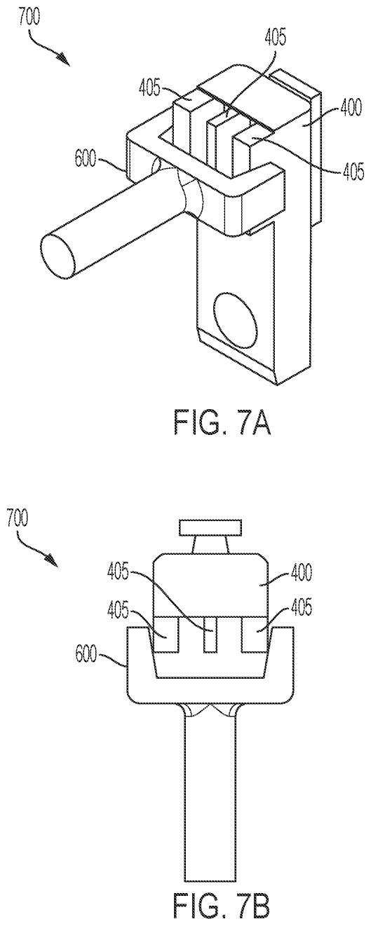

FIGS. 6A and 6B illustrate a fusing tip 600 (i.e., an electrode fusing tip 600) that may be located at the end of an electrode such as the positive electrode 505 shown in FIG. 5. The fusing tip 600 may be used during a securing process (e.g., welding) to electrically and mechanically connect/secure motor wires 520 to the terminal 400. The fusing tip 600 includes a shank 605 and a wire portion 610. The shank 605 is configured to contact the terminal 400 and/or the motor wires 520 stuffed between the terminal posts 405 of the terminal 400. The wire portion 610 is configured to couple/be connected to or integrated into the positive electrode 505. In the illustrated embodiment, the shank 605 has an exterior rectangular shape. On the interior, the shank 605 includes a first side surface 615, a second side surface 620, and a third side surface 625. In some embodiments, the first side surface 615 and the second side surface 620 form obtuse angles with respect to the third side surface 625. In other embodiments, the shank 605 has a cylindrical shape rather than a rectangular shape. In some instances, the shank 605 shown in FIGS. 6A and 6B and a cylindrical shaped shank may be referred to as U-shaped shanks. In some instances, a single U-shaped shank is configured to simultaneously contact an outside/outer portion of each outer terminal post 405 as shown in FIGS. 7A and 7B. In some instances, the shank 605 may be located on the negative electrode 515, for example, in instance in which the negative electrode 515 contacts the portion of the terminal 400 that includes the terminal posts 405 and the motor wires 520.

FIGS. 7A and 7B illustrate an arrangement 700 with the fusing tip 600 contacting the terminal 400 in a position that occurs during a securing process (e.g., welding) to secure the motor wires 520 to the terminal 400. While not shown in FIGS. 7A and 7B, in the arrangement 700, a second electrode 515 may be pressed against a central portion of the terminal 400 between the aperture 410 and an upper portion of the terminal 400 where the terminal posts 405 are located in a similar manner as shown in FIG. 5. The first and second side surfaces 615 and 620 of the fusing tip 600 mechanically engage the terminal posts 405 to help secure the fusing tip 600 in place and to prevent the outer terminal posts 405 from moving outwardly (e.g., away from a center of the terminal 400 where the center terminal post 405 is located) during a securing process (e.g., welding, fusing, etc.) to secure the motor wires 520 to the terminal 400.

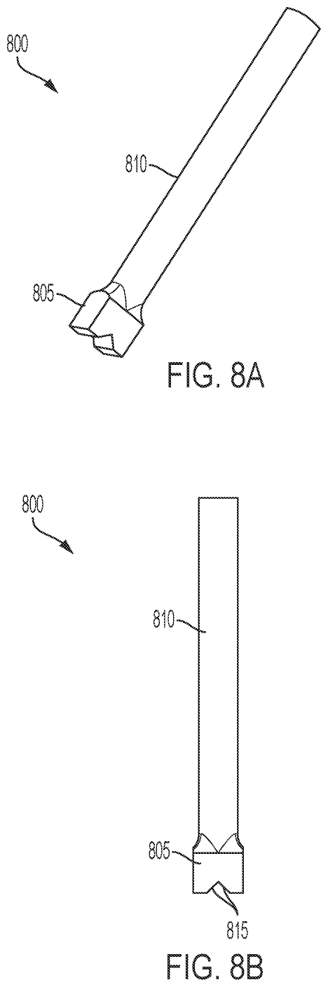

FIGS. 8A and 8B illustrate another fusing tip 800 that may be located at the end of one or more electrodes such as the electrodes 505, 515 shown in FIG. 5. The fusing tip 800 may be used during a securing process (e.g., welding) to electrically and mechanically connect/secure motor wires 520 to the terminal 400. Similar to the fusing tip 600 of FIG. 6, the fusing tip 800 includes a shank 805 and a wire portion 810. However, the shank 805 of the fusing tip 800 includes a V-shaped cutout formed by side surfaces 815. The V-shaped cutout may be formed by side surfaces 815 oriented at approximately a ninety degree angle with respect to each other. In some instances, the cutout angle may be smaller or larger than ninety degrees.

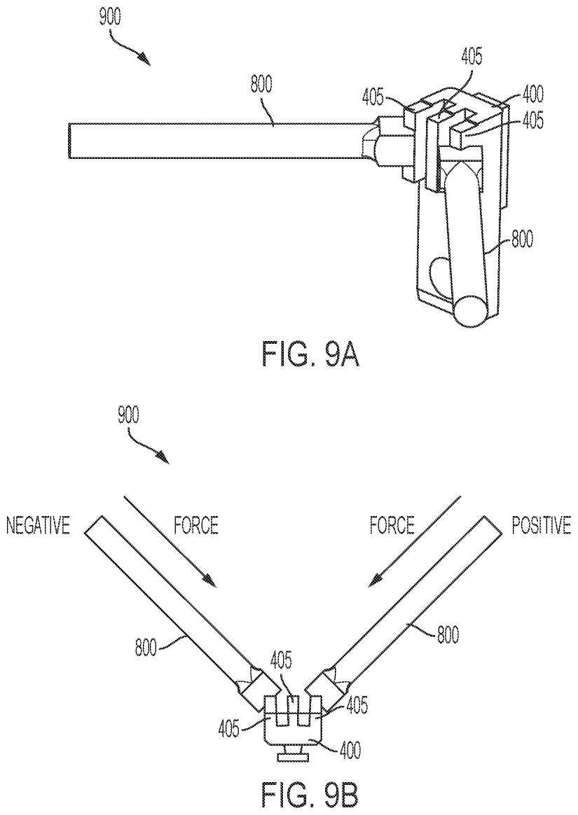

FIGS. 9A and 9B illustrate an arrangement 900 with two fusing tips 800 in contact with the terminal 400 at oblique angles (e.g., in contact with respective outer edges of respective outer terminal posts 405). For example, when the cutout angle of the shank 805 is approximately ninety degrees, an angle between an axis that runs through each of the fusing tips 800 is also approximately ninety degrees as shown in FIG. 9B. A first fusing tip 800 connected to a negative electrode 515 may be pressed in contact with a first terminal post 405 of the terminal 400 (e.g., a first outer terminal post 405). A second fusing tip 800 connected to a positive electrode 505 may be pressed in contact with a second terminal post 405 of the terminal 400 (e.g., a second outer terminal post 405 on an opposite lateral side of the terminal 400 as the first outer terminal post 405). The two fusing tips 800 mechanically engage the respective terminal posts 405 at the side surfaces 715 of the shank 705. The forces toward the terminal 400 from each fusing tip 800 help secure the fusing tips 800 in place also prevent the sides of the terminal 400 (e.g., the outer terminal posts 405) from pushing outwardly (e.g., away from a center of the terminal 400 where the center terminal post 405 is located) during the securing process (e.g., welding, fusing, etc.). In some instances, the polarity of the fusing tips 800 may be opposite to that shown in FIG. 9B (e.g., the left fusing tip 800 may be connected to a positive electrode and the right fusing tip 800 may be connected to a negative electrode).

Thus, some embodiments provide, among other things, a brushless motor including fused motor terminals and one or more methods for assembling the motor terminals that form a part of the brushless motor.

We claim:

1. A power tool comprising:
a housing;
a brushless direct current (DC) motor located within the housing and having a rotor and a stator, wherein the rotor is coupled to a motor shaft arranged to produce an output outside of the housing; and
a plurality of terminals mounted on an outer circumference of the stator, wherein each terminal of the plurality of terminals includes at least two terminal posts protruding from a surface of the terminal away from a motor axis about which the rotor is configured to rotate, wherein a slot is formed between the at least two terminal posts, and wherein the slot is configured to receive a motor wire;
wherein the motor wire received in each slot of each terminal is configured to be secured to its respective terminal, and
wherein, to secure the motor wire to its respective terminal:
a tip of a first electrode is pressed into contact with an outer portion of at least one terminal post of the at least two terminal posts, and
a current is controlled to pass through the first electrode to a second electrode that is also in contact with the respective terminal, wherein the current generates heat to conjoin the respective motor wire and the respective terminal,
wherein the tip of the first electrode is configured to prevent the at least one terminal post from moving outwardly away from a center of the respective terminal when being secured.

2. The power tool of claim 1, wherein, to press the tip of the first electrode into contact with the outer portion of the at least one terminal post, the tip of the first electrode is pressed into contact with respective outer portions of two terminal posts of the at least two terminal posts.

3. The power tool of claim 1, wherein the tip of the first electrode includes a U-shaped shank configured to contact the outer portion of each of two outer terminal posts of the at least two terminal posts.

4. The power tool of claim 3, wherein the U-shaped shank is one of cylindrically shaped and rectangularly shaped.

5. The power tool of claim 1, wherein, to secure the motor wire to its respective terminal:
a tip of the second electrode is pressed into contact with an outer portion of a second terminal post of the at least two terminal posts, wherein the second terminal post is located on a laterally opposite side of the surface of the respective terminal as the at least one terminal post;
wherein the tip of the second electrode is configured to prevent the second terminal post from moving outwardly away from the center of the respective terminal when being secured.

6. The power tool of claim 5, wherein the tip of the first electrode includes a V-shaped cutout configured to contact an outer edge of the at least one terminal post; and
wherein the tip of the second electrode includes the V-shaped cutout configured to contact an outer edge of the second terminal post.

7. The power tool of claim 1, wherein the first electrode includes a positive electrode and the second electrode includes a negative electrode.

8. The power tool of claim 1, wherein the motor wire is one of welded, fused, or a combination of being welded and fused to its respective terminal.

9. A method of assembling a motor, the method comprising:
for each respective terminal of a plurality of terminals,
inserting a portion of a motor wire into a slot on the respective terminal, wherein the slot is formed by at least two terminal posts protruding from a surface of the respective terminal;
pressing a tip of a first electrode into contact with an outer portion of at least one terminal post of the at least two terminal posts; and
performing a securing process by controlling current to pass through the first electrode to a second electrode that is also in contact with the respective terminal, wherein the current generates heat to conjoin the wire and the terminal, and wherein the tip of the first electrode is configured to prevent the at least one terminal post from moving outwardly away from a center of the terminal during the securing process;
mounting the plurality of terminals on an outer circumference of the motor adjacent to each other and in an orientation such that the at least two terminal posts protrude away from a motor axis about which a rotor of the motor is configured to rotate; and
installing the motor in a housing of a power tool.

10. The method of claim 9, wherein pressing the tip of the first electrode into contact with the outer portion of the at least one terminal post includes pressing the tip of the first electrode into contact with respective outer portions of two terminal posts of the at least two terminal posts.

11. The method of claim 9, wherein the tip of the first electrode includes a U-shaped shank configured to contact the outer portion of each of two outer terminal posts of the at least two terminal posts.

12. The method of claim 11, wherein the U-shaped shank is one of cylindrically shaped and rectangularly shaped.

13. The method of claim 9, further comprising pressing a tip of the second electrode into contact with an outer portion of a second terminal post of the at least two terminal posts, wherein the second terminal post is located on a laterally opposite side of the surface of the terminal as the at least one terminal post;
wherein the tip of the second electrode is configured to prevent the second terminal post from moving outwardly away from the center of the terminal during the securing process.

14. The method of claim 13, wherein the tip of the first electrode includes a V-shaped cutout configured to contact an outer edge of the at least one terminal post; and
wherein the tip of the second electrode includes the V-shaped cutout configured to contact an outer edge of the second terminal post.

15. The method of claim 9, wherein the first electrode includes a positive electrode and the second electrode includes a negative electrode.

16. The method of claim 9, wherein performing the securing process includes welding, fusing, or a combination of welding and fusing.

17. A method of securing a wire to a terminal, the method comprising:
inserting a portion of the wire into a slot on the terminal, wherein the slot is formed by at least two terminal posts protruding from a surface of the terminal;
pressing a tip of a first electrode into contact with an outer portion of at least one terminal post of the at least two terminal posts; and
performing a securing process by controlling current to pass through the first electrode to a second electrode that is also in contact with the terminal, wherein the current generates heat to conjoin the wire and the terminal;
wherein the tip of the first electrode is configured to prevent the at least one terminal post from moving outwardly away from a center of the terminal during the securing process.

18. The method of claim 17, wherein the tip of the first electrode includes a U-shaped shank configured to contact the outer portion of each of two outer terminal posts of the at least two terminal posts.

19. The method of claim 17, further comprising:
pressing a tip of the second electrode into contact with an outer portion of a second terminal post of the at least two terminal posts, wherein the second terminal post is located on a laterally opposite side of the surface of the terminal as the at least one terminal post;
wherein the tip of the second electrode is configured to prevent the second terminal post from moving outwardly away from the center of the terminal during the securing process.

20. The method of claim 19, wherein the tip of the first electrode includes a V-shaped cutout configured to contact an outer edge of the at least one terminal post; and
wherein the tip of the second electrode includes the V-shaped cutout configured to contact an outer edge of the second terminal post.
